(19) United States
(12) Patent Application Publication
(10) Pub. No.: US 2004/0096646 A1
(43) Pub. Date: May 20, 2004

(54) Light-weight wheel housing element

(76) Inventors: Uwe Behrendt, Nienhagen (DE); Dirk Trapp, Celle (DE)

Correspondence Address: James P Zeller, Marshall Gerstein & Borun, 6300 Sears Tower, 233 South Wacker Drive, Chicago, IL, 60606-6357, US

(21) Appl. No.: 10/467,688

(22) PCT Filed: Feb. 15, 2002
(86) PCT No.: PCT/EP02/01657

(30) Foreign Application Priority Data
Feb. 16, 2001 (DE) 101 07 430.1

(51) Int. Cl. B32B 3/00; B32B 3/26; B32B 9/00

(52) U.S. Cl. 428/318.4; 428/304.4; 428/318.6; 428/314.4

(57) ABSTRACT

The invention relates to a lightweight wheel housing part of plastic for reduction of the transmission of rolling noises, spray water noises and stone impact noises into the vehicle interior and for protection from corrosion, the plastic being foamed or expanded plastic. Furthermore, the invention relates to the use of thermoplastic plastic, duroplastic plastic, elastomer or mixtures thereof for the production of lightweight wheel housing parts.

The invention relates to a lightweight wheel housing part of plastic, for the reduction of the transmission of rolling noises, splash water noises and stone impact noises into the vehicle interior and for protection from corrosion. Further, the invention relates to the use of foamed or expanded thermoplastic plastic, duroplastic plastic, elastomer or mixtures thereof for the production of lightweight wheel housing parts.

As a rule, with vehicles the wheel arches are provided with a lining which is called a wheel housing, wheel housing shell, wheel house shell or wheel arch lining. The wheel housing part serves on the one hand for reduction of the transmission into the vehicle interior of the running noises generated during travelling of the vehicle through the wheel rotating on a surface. On the other hand the wheel housing part serves as spray protection against particles highly accelerated during travel, due to the rotating wheel, such as for example sand or gravel, and for protection against water or mud. The wheel housing part also brings about, in its function as spray protection, for example a protection of the bodywork or of the motor compartment from paintwork damage or corrosion and from contamination by highly accelerated particles and/or water or mud. Further, the wheel housing part also serves for covering over openings, such as for example ventilation openings, which in the rearward side region of the vehicle open into the vehicle bumpers.

Wheel housing parts which are employed purely as covers and as protection against corrosion are mostly produced of non-filled polypropylene and polyethylene in injection moulding or vacuum forming processes. These wheel housing parts bring about, however, only a slight reduction of the transfer of disruptive noises into the vehicle interior.

From DE 33 43 402 there is known a wheel housing part which along with good mechanical properties also has improved sound blocking and sound damping properties. In accordance with the teaching of DE 33 43 402, the wheel housing part is made of a plastic which comprises 25 to 40 wt % polyolefine and/or polystyrene with high impact resistance, 25 to 40 wt % synthetic rubber, 25 to 40 wt % an amorphous filler, and, if applicable, additives.

It is disadvantageous that the density of such a plastic is ca. 1150 kg/m³. With wall thicknesses from about 2 to 2.3 mm, wheel housing parts produced with the employment of the composition known from DE 33 43 402 have a high component weight. With regard to the constantly increasing efforts of the automobile industry to reduce component and vehicle weights, in particularly with regard to the generally demanded reduction of the average fuel usage of the vehicles, the high weights of these wheel housing parts are increasingly less accepted.

From EP 0 222 193 and from DE 295 17 046 there are known wheel housing parts having reduced weight. These wheel housing parts are based upon a plastic fiber non-woven, the wheel housing parts being produced through hot forming from web material. These wheel housing parts have, along with a reduced weight, also adequate acoustic properties.

It is, however, disadvantageous that the wheel housing parts known from EP 0 222 193 and from DE 295 17 046 take up large quantities of moisture or water. The water takeup of these wheel housing parts can amount to 200 wt % of the self-weight of the dry wheel housing part. The taken up moisture or the taken up water is then released from the wheel housing part, extremely disadvantageously, for example in the garage or with the formation of large water puddles.

Further, this wheel housing part takes up extremely disadvantageously large quantities of dirt particles, in particular of fibrous material but also of mud and dust. The dirt particles taken up approximately double the weight of this wheel housing part after about 80000 travelled kilometres. Further disadvantages arise from the production process. With hot forming of web material into the relatively complicated contours of the wheel housing part, large material wastage arises through the edge trimming.

As a rule, the fiber material has, along with the needlelooming a further strengthening which is attained through impregnation of the fiber material with a latex binder (SBR, styrol-butadiene-rubber) or with a binder based on acrylic resin. This has, however, the consequence that the fiber material and thus the edge trimmings, cannot be usefully recycled at the present time. This leads also to economic disadvantages, along with ecological problems with regard to the disposal of these remainders.

In accordance with a further proposed configuration, the plastic fiber non-woven is embedded in a flat heat formable carrier material. Here, the latex binder can be omitted, which basically makes possible recycling of the composite material, but however leads to a downgrading of the fiber non-woven material. Difficulties arise, however, with complex, three-dimensional geometries with rectangular shapes and/or small radiuses. These difficulties lead to constructional restrictions.

From DE 198 17 567.1 there is known a wheel housing part which is of a carrier frame of thermoplastic plastic and insets of a textile plastic material. In accordance with a preferred configuration, the plastic used for the carrier frame and for the textile plastic material is identical, whereby the plastic may contain 25 to 40 wt % of a mineral filler.

The thermoplastic plastic frame can be produced in an injection moulding process whereby pre-stamped non-woven inlays are injected directly around, or alternatively also after the injection moulding of the frame can be bonded with this by means or, gluing or ultrasonic welding. In each case, the cutting to shape of the non-woven material can be so carried out that only small quantities of non-woven waste arise. Since the component stiffness is achieved to the greater part through the frame of thermoplastic plastic, the inset non-woven material may be less stiff, which leads to a lesser employment of nonwoven material or binder or carriers. Taking into account a later recycling, the frame and the fiber non-woven should be made up of the same basic plastics.

The typical problems for fiber non-woven materials, of a high take up of water and the take up of dirt particles, are also of significance in the case of the wheel housing part known from DE 198 17 567. Due to the smaller surface areas covered over with fiber non-woven these problems are, however, less. The component weight is directly dependent upon the relationship of the area proportions of the plastic frame and of the fiber non-woven and lies between the weights of wheel housing parts of pure plastic fiber non-woven and those of pure plastic.

Further disadvantageous is that the employment of a plastic frame and of fiber non-wovens for the production of the wheel housing part known from DE 198 17 567 requires an increased outlay in terms of equipment for the production process.

There is thus a need for a further reduction of the component weight of the known wheel housing parts, and an improvement with regard to the take up of dirt particles and water by the wheel housing parts.

It is an object of the invention to make available a wheel housing part which has a light weight, takes up little water and dirt particles, makes possible a substantially complete recycling of the materials employed, has good acoustic properties, and is simple to produce.

The object on which the invention is based is attained through the making available of a lightweight wheel housing part of plastic for the reduction of the transmission of rolling noises, spray water noises and stone impact noises into the vehicle interior and for the protection from corrosion, whereby the plastic is foamed or expanded plastic.

Preferred embodiments are indicated in the subclaims.

The proportion of the plastic, referred to the overall weight of the wheel housing part, is preferably at least 80 wt %. In accordance with a further preferred embodiment, the proportion of the plastic is at least 85 wt %, preferably at least 90 wt %, in each case referred to the overall weight of the wheel housing part. Of course, the proportion of the plastic with the wheel housing part may also be higher, for example at least 95 wt %.

Further constituents may be additives which advantageously affect the workability or the properties of the plastics.

Additives may be for example lubricants, anti-blocking agents, release agents, stabilizers, anti-static agents, conductive additives, fire protection agents, colouring agents, agents affecting flexibility, plasticizers, adhesion promoters, reinforcing agents, expansion agents and mixtures thereof. Further there may also be contained in the plastic employed synthetic auxiliary materials such as catalysts, emulsifiers, precipitating agents, hardeners and/or accelerators.

The plastic of which the wheel housing part is produced has preferably a density of less than 500 kg/m³. In accordance with a preferred further development of the invention, the density.of the plastic is in a range from 10 to 300 kg/m³. Further preferred, the density of the plastic is in a range from 30 to 100 kg/m³.

It has been found, as a complete surprise, that the production of lightweight wheel housing parts which have good acoustic and also good mechanical properties, in particular a completely surprising resistance to stone impact, is possible.

For the production of the wheel housing part in accordance with the invention there are preferably employed thermoplastic plastic, duroplastic plastic and/or elastomers.

Preferably, polyolefines and/or vinyl polymers are employed as thermoplastic plastics. There are preferably employed as polyolefines polyethylenes, polypropylenes, polybutenes or mixtures thereof. Polyethylene, polypropylene and mixtures thereof have proved to be particularly suitable, As vinyl polymer, polystyrene is preferably employed.

There may, however, also be employed other plastics such as for example thermoplastic or duroplastic polyurethane.

Of course, polyolefines and/or vinyl polymers can also be employed as copolymers, such as for example as block copolymers or graft copolymers. Also it is possible to employ copolymers produced of polyethylene, polypropylene and/or polybutene, for example in the form of block or graft copolymers, in the production of the wheel housing parts in accordance with the invention.

The above-mentioned preferred thermoplastic plastic materials are available in large quantities at favourable prices and for this reason are particularly suitable for the production of mass production articles such as the wheel housing part in accordance with the invention.

For the production of a wheel housing part with the employment of foamed thermoplastic plastic material there can be employed plastic materials in which there are iS incorporated low boiling point substances, such as e.g. the hydrocarbons pentane to heptane, chlorinated hydrocarbons such as methylene chloride, trichloroethylene. There may added to the plastic material, however, also other expanding agents such as for example azo compounds, N-nitroso compounds or sulfonyl hydrazide. Extremely advantageously, the wheel housing parts can be produced of formed plastic in injection moulding, for example by means of thermoplastic foam moulding (TSG). Further, there can be employed for the injection moulding also so-called “MuCell” (Trademark) processes with the employment of supercritical carbon dioxide. The MuCell (Trademark) process was developed by Trexel and Engel (the Trexel Company, Woburn, Mass., USA; the Engel Company, Schwertberg, Austria).

In accordance with a further preferred embodiment the lightweight wheel housing part is produced with the employment of expanded thermoplastic plastic. In particular here, there is employed as thermoplastic plastic, polyethylene, polypropylene and/or polystyrene. Polypropylene has proved to be particular usable for the wheel housing part in accordance with the invention.

Here, the thermoplastic plastic materials may be pre-foamed with the addition of expanding agent, such as for example hydrocarbons, for example through suspension (bead) polymerisation with a granulate size of for example 0.2 to 0.3 mm, and with the use of steam at temperatures of 80° C. to 110° C., through which foam beads are obtained. For this purpose there may be employed pre-foamers which work discontinuously or continuously. The steam diffusing into the cell walls thereby supports the foaming process. The pre-foamed loose foam beads can then for example be brought into the tool or mould cavity for the wheel housing part, for example a tool for foam particle processing having steam nozzles, filler systems, cracking gaps etc., with gas permeable walls, whereby the air remaining in the charge of beads can be removed under the application of a vacuum.

With the supply of energy, for example in the form of steam, if applicable with high frequency excitation, the foam beads can then be softened at 100° C. to 160° C. and 0.5 to 5 bar. Through this the vapour pressure of the remaining expanding agent is increased, so that the foam beads expand further and thereby weld together.

The wheel housing part produced in this way is surprisingly stable in shape and has excellent acoustic properties, i.e. good sound damping and/or sound blocking properties, and excellent mechanical properties, i.e. good stability of shape and good resistance to impact.

With the wheel housing part in accordance with the invention extremely preferably no mineral fillers are added. With the employment of foamed or expanded plastic, such as polyethylene, polypropylene and/or polystyrene, and the omission of any mineral filler materials, as are conventionally employed, an extremely lightweight wheel housing component is made available.

The foamed or expanded thermoplastic plastic may have an open cell, closed cell or mixed cell-like structure. With an open or mixed cell structure it is preferred that the wheel housing part has on the surface a closed outer skin, so that moisture and water are not taken Up by the wheel housing part.

In accordance with a preferred embodiment the plastic has a substantially closed cell, preferably a closed cell, nature. The foam or expansion conditions can be so set that the desired closed cell nature can be obtained.

A closed cell nature of the plastic is preferred since even in the case of damage to the closed outer skin of the plastic, no moisture and no water can penetrate into the wheel housing part. With the formation of the plastic foam as closed cell foam only individual cells can be damaged for example by highly accelerated particles or objects such as for example stones, branches, glass shards. However, moisture which may have penetrated into the damaged cell or damaged cells cannot penetrate further into the interior of the wheel housing part.

The wheel housing part in accordance with the invention may extremely advantageously have a weight which corresponds to comparable wheel housing parts of non-wovens. It is also possible to produce the wheel housing parts in accordance with the invention with a lesser weight, referred to comparable wheel housing parts of nonwoven material. In comparison with wheel housing parts of non-woven material, the wheel housing parts in accordance with the invention have the advantage that the latter do not take up and hold to a great extent either moisture or water, or dirt particles. Further, in the production of the wheel housing parts in accordance with the invention, no edge wastage of non-woven materials arises, which with the great production, quantities is a significant economic advantage.

Further, the wheel housing parts in accordance with the invention can be produced by injection moulding. The process for the production of the wheel housing part in accordance with the invention is, in comparison with the process for the production of wheel housing parts of non-woven material, significantly simpler, since no non-woven material need be cut to size, placed in a mould and injected around.

Extremely advantageously, the wheel housing parts in accordance with the invention can be completely recycled. Used wheel housing parts, if applicable after cleaning of the plastic material, can be granulated. The granulate can, if applicable at least in part as an additive to a mixture, be employed in the new production of wheel housing parts. Of course, the granulate produced of used wheel housing parts can also be employed for the production of other products.

The wheel housing part in accordance with the invention is not restricted to particular geometrical dimensions. Further, the wheel housing part in accordance with the invention may have any constructional configuration which is required for the lining of the wheel arch or wheel arch housing.

Of course, the wheel housing part in accordance with the invention may also have shape stabilising elements such as for example bracings in the form for example of longitudinal and/or transverse ribs or grooves. These longitudinal and/or transverse ribs or grooves may be applied for example on the surface of the wheel housing. part away form the wheel or may be arranged integrated on the wheel housing part.

The arrangement of such shape stabilising elements may be effected in a separate working step. Preferably the tool or mould cavity has a corresponding shaping so that the shape stabilising elements such as for example longitudinal and/or transverse ribs or grooves are arranged integrated on the wheel housing part.

Extremely advantageously, with the wheel housing part in accordance with the invention there are no constructional restrictions, since even difficult shapings of the wheel housing part can be produced with the employment of all known direct three-dimensional shaping or moulding processes.

The wheel housing part in accordance with the invention may, with the employment of thermoplastic plastic materials, be extremely advantageously shaped through hot forming, preferably by means of deep drawing. With the preferably employed deep drawing process, the deep drawing can be effected with the employment of a stamp and/or with the application of a partial vacuum. In the hot forming, preferably deep drawing, preferably foamed webs are employed.

The shaped wheel housing part can further be lined partly or over its entire surface with a textile or foil-like material. Preferably, the wheel housing part is lined on the side towards the wheel. Of course, the side of the wheel housing part away from the wheel can also be at least partly lined. The lining/laminating with a textile or foil-like material can be effected during the moulding process or alternatively also subsequently in a further working step.

As foil-like material there can be employed any foil suitable for the provision of a skin on wheel housing parts. Such a foil brings about for example a strong protection of the wheel housing part against abrasive actions, arising for example through gravel, sand, etc. accelerated by the wheel. For example foils of the following materials can be applied: TPE (thermoplastic elastomer), ABS (acrylbutadienestyrol).

In accordance with a preferred embodiment of the invention there is employed expanded polypropylene, in the following also called EPP. EPP proves to be, completely surprisingly, very resistant to abrasive materials such as broken stones, gravel, sand etc., in various material densities and thicknesses.

Here, there were carried out stone impact laboratory tests for periods of many hours in accordance with the Mercedes Benz standard “Lacktechnische Prüfvorschrift” (Paintwork Test Guideline) LPV 6100.65004, which showed the surprising utility of wheel housing parts produced of EPP. After conclusion of the stone impact laboratory test there could be found only a slight roughening of the impacted EPP surface. Surprisingly, the wheel housing part produced of EPP demonstrated an increased resistance time as compared with wheel housing parts found in serial production. Through the provision of an additional skin of the surface, the resistance capability with respect to abrasive material can be further improved.

In acoustic tests it was shown that wheel housing parts of EPP reduced the transmission of stone impact noises, spray water noises and rolling noises into the vehicle interior in a comparable manner to wheel housing parts presently used in serial production. In dependence upon the installation of the EPP wheel housing part and the kind of cause concerned, there is provided even in part a significant reduction of noise level. In particular in the region with direct sheet metal contact, such as for example bolting points, constrictions etc., EPP wheel housing parts are superior to conventional wheel housing parts.

The acoustic and the general mechanical properties can be influenced through the choice of the employed EPP variant, e.g. the density and hardness, the surface configuration and the geometrical configuration of the wheel housing part, for example through napping, embossing, strengthening, profiles etc.

Particulary advantageous is the extremely slight weight of the EPP wheel housing parts, compared with the conventionally employed wheel housing parts, as will be shown below. Below,. the weights of wheel housing parts are indicated which have the same dimensions and are employed for mid-range vehicles:

wheel housing part of mineral-filled, elastomer-modified polypropylene: ca. 1700 g

wheel housing part of non-filled, elastomer-modified polypropylene: ca. 1300 g

wheel housing part with textile ca. 700 g

EPP wheel housing part (density: 60 kg/m³, wall thickness 10 to 15 mm) ca. 500 g

As can be seen from the above listing, the employment of EPP makes possible the production of wheel housing parts with an extremely slight weight, compared with conventional wheel housing parts. With regard to the weight of wheel housing parts which are produced with employment of textiles, the reduction of the weight is less strongly manifest. However, during use, the textile wheel housing parts take up great quantities of dirt and, in the wet, additionally great quantities of water or moisture, into the textile structure. The dirt take-up leads, as indicated in the introduction, after ca. 80 000 km to a doubling of the weight of the wheel housing part.

The water take up by an EPP wheel housing part is, in contrast, extremely advantageously, very slight. The water take up amounts, after keeping in water for seven days in accordance with DIN 53 428 (“Testing of Foams. Determination of behaviour with respect to fluids, vapours gas and solid materials”), to less that 2 wt %. Beyond this, the EPP wheel housing part manifests a contamination during use which corresponds to that of a wheel housing part of elastomer-modified polypropylene.

Extremely advantageous is also that the increase in weight due to the take up of dirt and/or moisture is very slight with the EPP wheel housing part in accordance with the invention.

Finally, the EPP wheel housing part is, in contrast to conventional wheel housing parts, totally recyclable in accordance with European Union vehicle disposal rules. The EPP wheel housing part in accordance with the invention thus represents a significant advance with regard to ecological and economic aspects.

A further advantage is that the EPP wheel housing parts can be simply produced in great quantities in one production procedure.

Along with Neopolen produced the company BASF, Ludwigshafen, Germany, EPP of other manufacturers can be employed, such as e.g. pf the company FAGERDALA INDUSTRI AB, Gustavsberg, Sweden; the company Gefinex GmbH, Steinhagen, Germany; JSP International, Japan.

### Experimental Investigations

### I. Evaluation of Acoustic Properties

With the employment of Neopolen (company BASF, Ludwigshafen, Germany) there were produced EPP example parts with the foaming automatic machine Unimat 2/A belonging to the company Teubert, Slumber, Germany. The production. conditions of the EPP example parts corresponded to the usual conditions in the production of EPP moulded bodies: steam pressure: ca. 4 bar, steam temperature: 140° C. to 150° C.

For acoustic measurements, there were produced EPP plates with thickness and, density corresponding to those for wheel housing parts. The thickness of the EPP plates was 10 mm and the density was 60 kg/m³.

For comparative purposes, plates were produced of mineral-filled thermoplastic material, namely BaryLiner. The thickness of the BaryLiner plates was 3 mm and the density was 1150 kg/m³. The production of the plate material of BaryLiner was effected as described in DE 33 43 402. BaryLiner is an elastomer-modified polypropylene of the company Stankiewicz, Celle, Germany.

For evaluation of the acoustic effect of wheel housing parts in the vehicle there was imitated the effect of stone impacts, such as for example gravel and spray water. Thereby, the structure with wheel housing part was compared with the metal sheet lying therebehind without wheel housing part.

The capability of reducing the level of airborne sound in the case of solid-borne sound excitation was determined with the employment of Barytest apparatus. The Barytest apparatus is a device for determining the sound emission of a plate excited to solid-borne sound by means of metal impactors. Thereby, the resulting airborne sound level is measured with the employment of a microphone on the side of the plate opposite to the excited side.

With the employed measurement apparatus there impact upon the underside of a horizontally mounted body panel an arrangement of metal impactors in random order. As when driving over gravel this represents a solid-borne sound excitation of the wheel housing consisting of many individual impulses. On the opposite side of the sheet the airborne sound pressure level was measured for determining the resulting airborne sound emission and serves as reference for the arrangements having wheel housing part material (wheel housing shell material) placed in front in a form of a plate. The arrangement of the metal impactors and of the receiving microphone are in each case surrounded with a sheet lining in the form of a box, whereby the box shapes are in each case open in the direction of the plate material to be investigated, arranged horizontally between the box shapes. For determining the acoustic improvement, the resulting sound pressure level of the arrangement with the wheel housing part material placed in front was subtracted from the reference level.

### 1st Arrangement

The wheel housing part material to be evaluated was arranged directly under the steel sheeting in the shape of a plate, with the employment of a clamping frame on the other side. The solid-borne sound excitation through the metal impactors was effected from below onto the wheel housing part material. The air pressure level of the resulting emission of the bear sheet was measured from above by means of a microphone.

### 2nd Arrangement

The wheel housing part was placed with a frame at an air spacing in front of the steel sheeting, so that the overall structural height wheel housing shell—steel sheeting was 20 mm. The sound pressure level of the resulting emission of the bare sheet was measured from above as with the case of the 1st arrangement.

### Result

The level difference of the sound pressure sum levels (400-8000 Hz) are indicated in Table 1.

TABLE 1
comparison of the sound pressure sum levels of
plates produced of BaryLiner and of EPP.

| | BaryLiner | EPP |
|---|---|---|
| Wheel housing part with direct sheet | 5.8 dB | 17.4 dB |
| contact (1st Arrangement) | | |
| Wheel housing part with air spacing | 14.6 dB | 16.9 dB |
| from sheeting (2nd Arrangement) | | |

As can be seen from Table 1, a wheel housing part of EPP exhibits an airborne sound level reduction comparable with, partly improving upon, that of a conventional wheel housing part produced of BaryLiner. EPP is thus a suitable material for the reduction of solid-borne sound due to stone impacts or spray water.

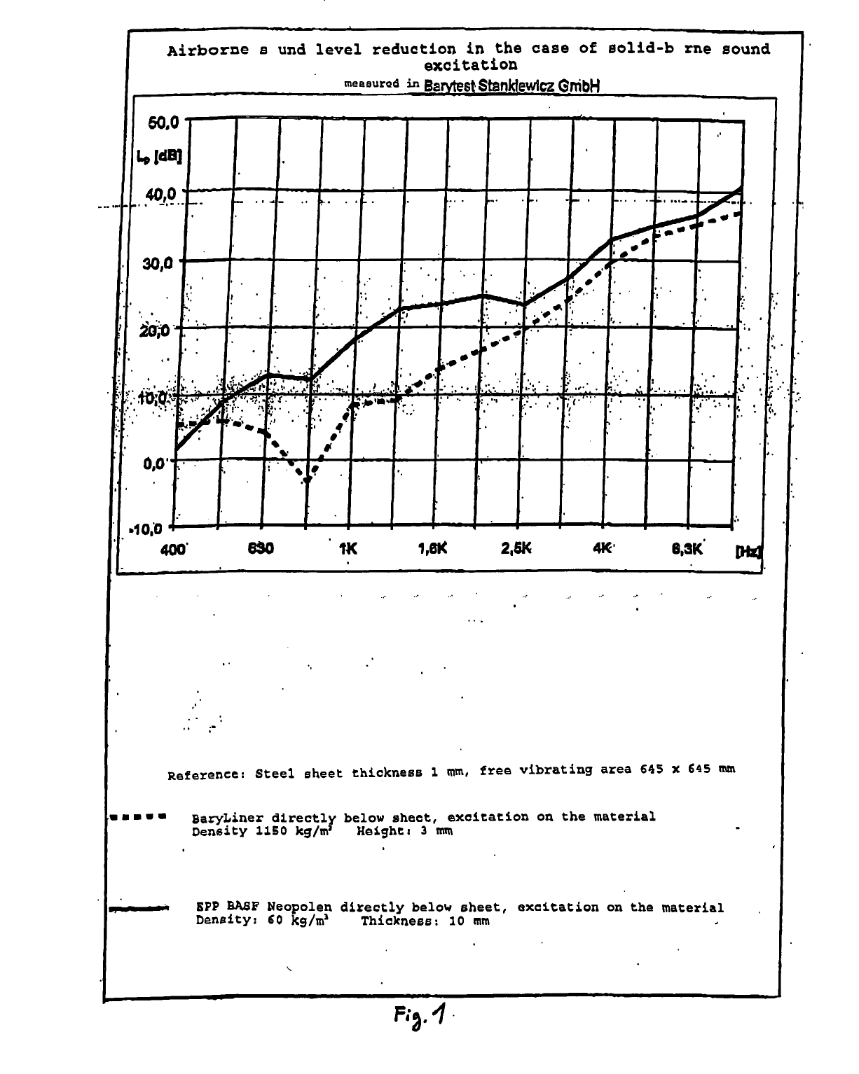

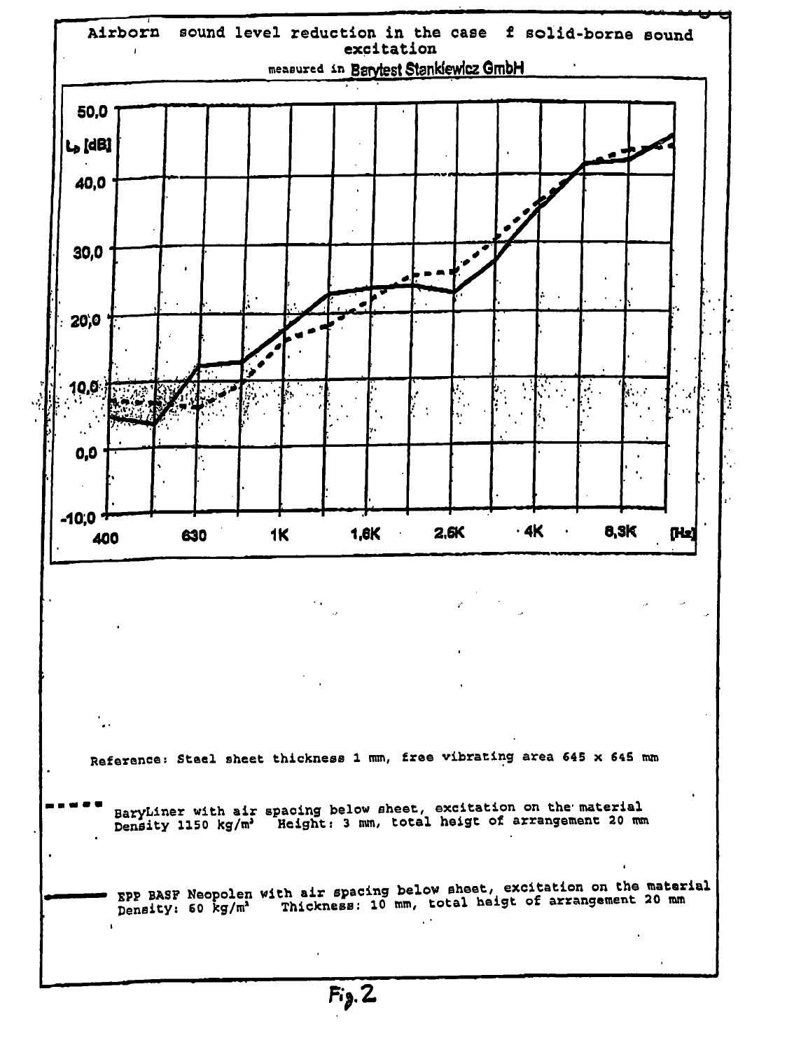

For further illustration of the above indicated results, the respective measurement curves are provided as FIG. 1 and FIG. 2.

FIG. 1 shows the measured difference sound pressure level Lp between the bare sheet.as reference and the arrangement of sheet and damping plate with the 1st arrangement.

Curve 1 (continuous line) shows the difference sound pressure level of a 1 mm thick steel sheeting having a free vibration area of 645×645 mm, on which there is arranged an EPP plate (EPP BASF Neopolen) having a density of 60 kg/m³ and a thickness of 10 mm.

Curve 2 (broken line) shows the difference sound pressure level of a 1 mm thick steel sheeting with a free vibration area of 645×645 mm, on which there is arranged a BaryLiner plate with a density of 1150 kg/m³ and a thickness of 3 mm.

FIG. 2 shows the measured difference sound pressure level Lp between the bare sheet as reference and the arrangement of sheet and damping plate with the 2nd arrangement.

Curve 1 (continuous line) shows the difference sound pressure level of a 1 mm thick steel sheeting with a free vibration area of 645×645 mm, above which there is arranged, with the formation of an air spacing, an EPP plate (EPP BASF Neopolen) having a density of 60 kg/m³ and a thickness of 10 mm, whereby the overall height of the arrangement was 20 mm.

Curve 2 (broken line) shows the difference sound pressure level of a 1 mm thick steel sheet having a free vibration area of 645×645 mm, above which there is arranged with the formation of an air spacing, a BaryLiner plate having a density of 1150 kg/m³ and a thickness of 3 mm, whereby the overall height of the arrangement was 20 mm.

### II. Water Take Up Capacity

For investigation of the capacity to absorb water there was arranged in water in accordance with DIN 53 428, a foamed EPP shaped part with a closed surface and having a density of ca. 60 kg/m³. After one day, the EPP shaped part had taken up 0.9 wt % water and after seven days 1.7 wt % water. The indications of wt % prefer in each case to the total weight of the shaped part.

The wheel housing part in accordance with the invention thus has, extremely advantageously, a very slight capacity to take up water.

### III. Mechanical Properties

For investigation of the mechanical properties EPP plates were directly adhered to a sheet and in accordance with the Paintwork Testing Guidelines of Mercedes Benz LPV 6100.65004, 1991, continuous stone impact tests were carried out. With the continuous stone impact test, sample materials adhered to a sheet are blasted with stone chips.

In these tests, with non-woven wheel housing parts found in serial production use, holes could be recognised in the non-woven material even after only 60 minutes.

For the comparative test the following non-woven material was employed: PET non-woven (PET: polyethyleneterephthalate) with SBR binder (SBR: styrolbutadienelastomer), density ca. 1100 g/m², and polyester needleloom non-woven with an extruded polypropylene back coating, density ca. 1100 g/m² mm.

EPP samples of various thicknesses, namely having a thickness of ca. 5, 6-7, 10 and 20 mm, and densities, namely having a density of 29, 47 and 80 kg/m³, showed no holes even after 60 minutes of blasting with stone chips. There was solely a light roughening of the surface. Even after seven hours blasting with stone chips, the EPP samples had no holes but did show significant damage.

1. Lightweight wheel housing part of plastic for reduction of the transmission of rolling noises, spray water noises and stone impact noises into the vehicle interior and for protection from corrosion, characterised in that,
the plastic is foamed or expanded plastic.

2. Lightweight wheel housing part according to claim 1, characterised in that,
the proportion of the plastic is at least 80 wt %, referred to the overall weight of the wheel housing part.

3. Lightweight wheel housing part according to claim 1 or 2, characterised in that,
the plastic has a density of less than 500 kg/m³.

4. Lightweight wheel housing part according to any preceding claim, characterised in that,
the plastic has a density between 10 kg/m³ and 300 kg/m³, preferably between 30 kg/m³ and 100 kg/m³.

5. Lightweight wheel housing part according to any preceding claim, characterised in that,
on the outer surface of the wheel housing part the plastic has a closed outer skin.

6. Lightweight wheel housing part according to any preceding claim, characterised in that,
the plastic has a substantially closed-cell nature.

7. Lightweight wheel housing part according to any preceding claim, characterised in that,
the plastic contains no mineral fillers.

8. Lightweight wheel housing part according to any preceding claim, characterised in that,
the plastic is selected from the group consisting of thermoplastic plastic, duroplastic plastic, elastomers and mixtures thereof.

9. Lightweight wheel-housing part according to claim 8, characterised in that,
the thermoplastic plastic is polyolefine, vinyl polymer or mixtures thereof.

10. Lightweight wheel housing part according to claim 9, characterised in that,
the polyolefine is selected form the group consisting of polyethylene, polypropylene, polybutene and mixtures thereof.

11. Lightweight wheel housing part according to claim 9, characterised in that,
the vinyl polymer is polystyrene.

12. Lightweight wheel housing part according to any preceding claim, characterised in that,
the plastic contains additive(s) with a proportion of less than 20 wtt, preferably less than 10 wt %, referred to the overall weight of the plastic.

13. Lightweight wheel housing part according to any preceding claim, characterised in that,
the wheel housing part is hot formed, preferably deep drawn.

14. Lightweight wheel housing part according to any preceding claim, characterised in that,
the wheel housing part is lined at least on the side towards a wheel, partially or over its entire area, with a textile or foil-like material.

15. Use of foamed or expanded thermoplastic plastic, duroplastic plastic, elastomer or mixtures thereof for the production of lightweight wheel housing parts according to any claims 1 to 14.

16. Use according to claim 15, whereby the thermoplastic plastic is polyolefine, preferably polyethylene, polypropylene and/or polybutene and/or vinyl polymer, preferably polystyrene.
